(19) United States
(12) Patent Application Publication
(10) Pub. No.: US 2010/0232771 A1
(43) Pub. Date: Sep. 16, 2010

(54) TIME-SENSITIVE REMOTE CONTROL OF A VIDEO PLAYBACK DEVICE

(75) Inventors: Kyle J. Prestenback, Burbank, CA (US); Evan H. Tahler, Burbank, CA (US)

Correspondence Address: DISNEY ENTERPRISES, INC;C/O SMITH FROHWEIN TEMPEL GREENLEE BLAHA LLC, TWO RAVINIA DRIVE, SUITE 700, ATLANTA, GA, 30346, US

(73) Assignee: Disney Enterprises, Inc., Burbank, CA (US)

(21) Appl. No.: 12/404,437

(22) Filed: Mar. 16, 2009

(51) Int. Cl. H04N 5/00; H04N 7/16

(52) U.S. Cl. 386/126; 386/E05.001; 725/143

(57) ABSTRACT

One or more media players are remotely controlled via a data network in a manner that synchronizes the playback state of each media player with the playback state of a master device.

### BACKGROUND

The playback of movies, music and other content recorded on optical disks or other packaged media has become commonplace. For example, it is common to insert a prerecorded optical disc into a computer disc drive and use a virtual, i.e., software-based, player to view the content on the computer screen. Integrated video disc players, i.e., machines that have integral screens, can be used similarly. However, the use of computers and computer-like devices to play back content is rooted in the use of standalone players, i.e., player machines that output signals to television screens. Indeed, standalone media players remain quite popular, and it is common for persons to rent or purchase discs to view movies, television shows, and other content through television screens and other home entertainment systems via a standalone player. Newer high-definition (HD) video formats and economical large-screen HD televisions have helped maintain the popularity of this mode of playback.

Videocassette recorders (VCRs) were for many years the dominant type of playback device for consumer use. A VCR is a machine to which a person can connect a television and play back (and record) a videocassette, in which the signals are recorded on magnetic tape. Movies, television shows, and other titles were widely available for rental or purchase on the videocassette medium.

Optical disc media have largely supplanted the videocassette. A common optical disc format is known as DVD. The recording medium (disc) itself is known simply as a DVD. A DVD player plays back a DVD in a manner analogous to that in which a VCR plays back a videocassette. However, the DVD format provides a number of improvements, including on-screen menus that a user can navigate using a remote control. When a person inserts a DVD into a DVD player, the player responds not only to recorded video signals but to recorded data files that include predefined commands for generating on-screen displays, such as menus, sub-menus, and sub-screens. Upon inserting a DVD, the user is typically presented with a main menu listing one or more options, from which the user can select an option using the remote control. The menu options typically include playing back the movie or other main content item in its entirety, navigating to a selected scene or other sub-portion for playback, and navigating to movie trailers, commentary, or other such “bonus material.”

A newer generation of optical disc technology provides improved HD video formats and media storage capacity and encompasses so-called “smart” media players. One such technology is known as Blu-ray Disc®. (Blu-ray Disc is a registered trademark of the Blu-ray Disc Association, a consortium of consumer electronics, computer, and media manufacturers.) Media players that take advantage of advanced features of this newer generation of optical disc technology are referred to as smart media players because they can perform operations that are significantly more complex and computer-like than the simple menu navigation and other operations provided under the DVD standard. This next generation of standards contemplates that media players may include non-volatile data storage, such as solid-state (e.g., flash) memory and magnetic disk drives, as well as programmable processor systems that can execute versatile programming code (such as Java code) read from the disc. In addition, some media players include interfaces for connection to the internet.

Media players, including Blu-ray Disc, DVD, videocassette and other formats, commonly include a user interface that provides at least the following functions or similar functions: A Play function that, when activated by a user, causes the media player to begin playing the disc or other medium; a Stop function that, when activated by a user, causes the media player to cease playing the disc or other medium; a Forward function that, when activated by a user, causes the media player to move the playback point in a forward direction through the recorded content item; and a Reverse function that, when activated by a user, causes the media player to rapidly move the playback point in a reverse direction through the recorded content item. Some media players, such as those that include data interfaces, can be controlled remotely. Media players can also be connected to each other through such data interfaces. For example, a master media player can be used to control a number of slave media players to which it is connected. Thus, for example, if a user activates the Play function on the master media player, the slave media players respond by activating their Play functions.

### SUMMARY

Embodiments of the present invention relate to a system and method for remotely controlling one or more media players via a data network in a manner that synchronizes the playback state of each media player with the playback state of a master device, such as a similar (master) media player, a computer-based system, or a combination of such devices. In exemplary embodiments, a person uses the master device to play back a packaged medium comprising a recording medium, such as an optical disc, on which a content item, such as a film, television show, or the like, is recorded. The master device has a media player user interface that responds to playback commands received from a user, such as Play, Stop, Pause, Reverse, Forward, etc. The master device transmits synchronization information via the data network. The synchronization information can include anything usable by a remote standalone media player to synchronize its playback state with the playback state of the master device. For example, synchronization information can include indications of the above-referenced playback commands. Alternatively or in addition, in some embodiments the synchronization information can include timecode information, indicating the point in the content item at which the master device is then playing back the content item. One or more standalone media players can receive the synchronization information via the data network and, in response, synchronize their playback states to the playback state of the master device.

The standalone media player can be a “smart” media player, such as a Blu-ray Disc® player. As a “smart” media player, it can not only play content recorded on the discs or other packaged media but also execute programming code recorded on the packaged media. In some embodiments, at least in part under control of such code, a media player can receive the synchronization information via the data network and, in response, synchronize its playback state to the playback state of the master device. Alternatively or in addition, in some embodiments some or all of the logic that causes the standalone media player to synchronize its playback state to the playback state of the master device can reside in the media player itself.

Other systems, methods, features, and advantages of the invention will be or become apparent to one of skill in the art to which the invention relates upon examination of the following figures and detailed description. All such additional systems, methods, features, and advantages are encompassed by this description and the accompanying claims.

### BRIEF DESCRIPTION OF THE FIGURES

The invention can be better understood with reference to the following figures. The elements shown in the figures are not necessarily to scale, emphasis instead being placed upon clearly illustrating the principles of the invention. Also, in the figures like reference numerals designate corresponding elements throughout the different views.

FIG. 1 illustrates a system in which a standalone media player receives synchronization information from a media player-based master device via a data network and, in response, synchronizes its playback state to the playback state of the master media player, in accordance with an exemplary embodiment of the invention.

FIG. 2 illustrates a system in which a standalone media player receives synchronization information from a computer-based master device via a data network and, in response, synchronizes its playback state to the playback state of the computer-based master device, in accordance with another exemplary embodiment of the invention.

FIG. 3 illustrates a system in which a standalone media player receives synchronization information from a master device via a data network and, in response, synchronizes its playback state to the playback state of the master device while an audio or video conference between the users of the master device and standalone media player occurs, in accordance with still another exemplary embodiment of the invention.

FIG. 4 illustrates a system in which each of a plurality of standalone media players receives synchronization information from a master device via a data network and, in response, synchronizes its playback state to the playback state of the master device, in accordance with exemplary embodiments of the invention.

FIG. 5 is a block diagram of an exemplary master device.

FIG. 6 illustrates processing system logic in the exemplary master device of FIG. 5.

FIG. 7 is a block diagram of an exemplary standalone media player or slave device.

FIG. 8 illustrates processing system logic in the exemplary standalone media player device of FIG. 7.

FIG. 9 is a flow diagram illustrating a method in which a standalone media player receives synchronization information from a master device via a data network and, in response, synchronizes its playback state to the playback state of the master device, in accordance with an exemplary embodiment of the invention.

FIG. 10 is a flow diagram similar to FIG. 9, in accordance with another exemplary embodiment of the invention.

### DETAILED DESCRIPTION

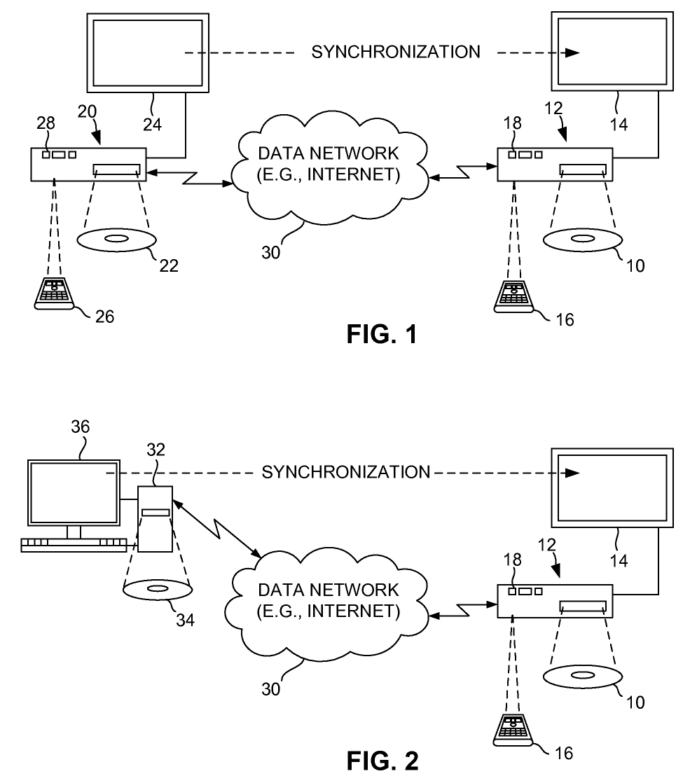

As illustrated in FIG. 1, in an illustrative or exemplary embodiment of the invention, a user can insert an optical disc 10 into a so-called “smart” media player 12, such as a Blu-ray Disc®-compatible player, and then cause media player 12 to play disc 10. As the term is used herein, “playing” disc 10 comprises media player 12 reading encoded content that is recorded on disc 10, decoding the content, and providing the content stream in a suitable electronic format to a television display (also referred to as a screen) 14 or similar device to which media player 12 can be connected. Media player 12 is a standalone device, i.e., it can play disc 10 without being connected to another device. Except for media player features described herein as relating to the present invention, media player 12 can be of a conventional type.

A user can interact with media player 12 through a user interface, which can include a handheld remote control 16 and front-panel buttons 18. Buttons 18 can be associated with user-input commands for controlling media player 12, such as Play, Stop, Pause, Forward, Reverse or other commands of the types commonly provided in such media players for activating player functions. A user can press a button 18 to input a command to activate a corresponding function. Similarly, media player 12 can also provide an on-screen display (not shown) that includes graphical indications of such commands. A user can use remote control 16 to similarly input a command to activate a function. In response to a Play command, media player 12 begins playing disc 10 from a point in the content referred to herein as the playback point. Typically, when a user first inserts or loads disc 10 into media player 12, media player 12 sets the playback point to zero (e.g., “00:00:00” in terms of hours, minutes and seconds). As media player 12 plays disc 10, media player 12 advances the playback point in accordance with a timecode that is associated with the recorded content. For example, 15 seconds after beginning playing a content item, the playback point is 00:00:15, corresponding to a timecode of 00:00:15. A disc 10 may have the timecode recorded on it along with the corresponding content. A user can stop playback by inputting a Stop command using remote control 16 or buttons 18. In response to a Stop command, media player 12 ceases playing disc 10 at the then-current playback point. A Pause command can also be included to briefly pause playback at the then-current playback point. A user can also cause media player 12 to move the playback point in forward or reverse directions through the content. For example, in response to a Forward (also known as Fast Forward) command, media player 12 moves the playback point forward. In response to a Reverse (also known as Rewind) command, media player 12 moves the playback point in the reverse direction. The above-described Play, Stop, Pause, Forward and Reverse commands are intended only as examples, and other commands can be included in addition to or alternatively to these exemplary commands in other embodiments.

Although in the exemplary embodiment media player 12 plays optical discs 10, such as Blu-ray Disc-compatible discs, in other embodiments a media player can play any other type of packaged medium that is compatible with that media player. The term “packaged medium” is used herein to refer to a disc or other digital recording medium that a person can obtain such as through conventional retail channels and on which content has been pre-recorded by or at the direction of a party responsible for the production of the packaged medium or its content. Although the term “packaged” medium as used in the art is intended to evoke the commercial manner in which such media are typically provided to consumers who purchase or rent them (i.e., in a box, case or similar commercial packaging), the term “packaged medium” is used herein to mean the recording medium only and does not encompass any packaging materials. The medium can be optical, magnetic, magneto-optical, solid state, or any other suitable type, and can have any suitable physical form, such as a disc, memory module, etc. In the exemplary embodiment, for example, the medium can be a Blu-ray Disc-compatible medium. The related term “packaged media product” is used herein to refer to a set of one or more packaged media on which the content item is recorded and, in some embodiments, also program code for instructing media player 12. As used herein, the term “content item” refers to a movie, serial, newscast, sportscast or other work characterized by its entertaining or informational nature. Content items specifically include (but are not limited to) movies, serials, newscasts, sportscasts, and other works of the types that have long been made available to consumers on various conventional packaged media, such as videocassette, DVD, and more recently, Blu-ray Disc-compatible disc. For example, in the exemplary embodiment disc 10 includes, in addition to the optical disc medium itself, a movie or other content item recorded in a Blu-ray Disc-compatible format on the medium. It should be noted that the manner in which such content items can be recorded on a packaged medium is well understood in the art and therefore not described herein.

The system shown in FIG. 1 also includes a media player-based master device 20. Media player-based master device 20 is in some respects similar to media player 12. For example, in a manner similar to that in which a user can play disc 10 on media player 12, a user can insert a disc 22 into media player-based master device 20 and then cause media player-based master device 20 to play disc 22. Media player-based master device 20 outputs the content stream in a suitable electronic format to a television display 24 or similar device to which media player-based master device 20 can be connected. Media player-based master device 20 can include a user interface similar to that of media player 12, including a remote control 26 and front-panel buttons 28. Although media player-based master device 20 is similar in these respects to media player 12 and is depicted in FIG. 1 for purposes of convenience of illustration as being similar to media player 12, media player-based master device 20 can include different or additional elements from those of media player 12 and can have a different physical form. For example, although not shown in FIG. 1, media player-based master device 20 can comprise a system of two or more devices, such as a combination of a media player and a computer or other equipment. Furthermore, media player-based master device 20 need not include a standalone media player; rather, media player elements can be included in combination with other elements or devices to provide media player functionality.

As described in further detail herein, media player 12 synchronizes its operating state to a playback state of media player-based master device 20. For example, when a user inputs a Play command (e.g., by pressing a button 28 or using remote control 26), media player-based master device 20 provides synchronization information to media player 12 via internet 30 or other suitable data network. Media player 12 uses the received synchronization information to synchronize its playback state to the playback state of media player-based master device 20. The term “playback state” encompasses within its scope of meaning, by way of example and not of limitation, whether media player-based master device 20 is playing, stopped, paused, forwarding, reversing, etc. Thus, for example, if media player-based master device 20 begins playing disc 22 (e.g., in response to a user having input a Play command), media player 12 responds by beginning playing disc 12. In the sense of a master-slave control system, media player-based master device 20 acts as a master device, and media player 12 acts as a slave device.

Media player-based master device 20 and media player 12 can communicate data with each other via internet 30. Each of media player-based master device 20 and media player 12 can be connected to internet 30 in any suitable manner known in the art, such as via one or more intermediary internet service provider networks or gateways (not shown).

As illustrated in FIG. 2, a system similar to that shown in FIG. 1 can be used in a manner similar to that in which the system of FIG. 1 is used, but which includes a computer-based master device 32 instead of media player-based master device 20. A user can insert an optical disc 34 into computer-based master device 32 and then cause computer-based master device 32 to play disc 34. Computer-based master device 32 outputs the resulting content stream in a suitable electronic format to a display 36 or similar device to which computer-based master device 32 can be connected. Computer-based master device 32 can include a user interface suitable for a computer system, such as a user interface that provides output via a display screen and receives input via a keyboard, mouse, etc. The user interface of computer-based master device 32 provides the same user-selectable input options as the user interface of media player-based master device 20 (FIG. 1) but in a manner suitable for a computer system. For example, while the user interface of media player-based master device 20 may provide a button 28 that a user can press to activate the Play function, the user interface of computer-based master device 32 may display a Play icon or graphical button that a user can click on with a mouse or other pointing device. Although computer-based master device 32 is similar in these respects to media player-based master device 20 and is depicted in FIG. 2 for purposes of convenience of illustration as having a computer-like form, computer-based master device 32 can comprise any suitable device or devices, such as a combination of a computer and a media player or other equipment. Furthermore, computer-based master device 32 need not include a general-purpose desktop computer, laptop computer, etc.; rather, computer elements such as disc drives, motherboards, memory, and the like can be included in combination to provide computer-like functionality along with media player functionality.

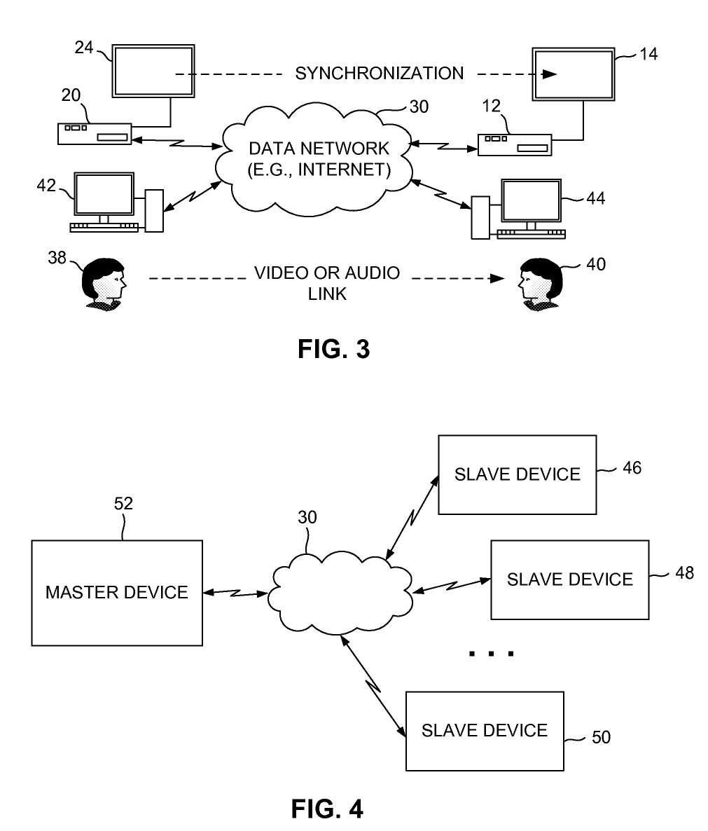

As illustrated in FIG. 3, a system similar to that described herein with regard to FIGS. 1 and 2 further allows a user 38 of media player-based master device 20 to communicate with a user 40 of media player 12. In addition to the elements described herein with regard to FIG. 1, the system further includes a master computer 42 accessible to user 38 and a user computer 44 accessible to user 40. Master computer 42 and user computer 44 can communicate data with each other via internet 30. The data can include encoded audio and video, such that users 38 and 40 can conduct an audio conference or video conference with each other via their respective computers 42 and 44. Although in this exemplary embodiment the conference occurs through computers 42 and 44 and internet 30, in other embodiments such a conference can occur through any other suitable devices and communication media, such as via telephones and a telephone network (not shown).

It should be understood that although a single master device and slave device are shown in the embodiments described herein with regard to FIGS. 1-3, in other embodiments any suitable number of slave devices can be included. For example, as illustrated in FIG. 4, each of several slave devices 46, 48, 50, etc., synchronizes its playback state to a playback state of a master device 52. Furthermore, although in the exemplary embodiments described herein slave devices 46, 48, 50, etc., are standalone media players 12, in other embodiments a slave device can be any other suitable media playback platform, such as a video-enabled wireless telephone or similar wireless device that stores one or more content items.

The systems shown in FIGS. 1-4 and similar systems can be used, for example, by persons associated with a content item, such as a movie, and others who have an interest in the movie or in such persons. With regard to FIG. 1, for example, discs 10 and 22 can relate to the same packaged media product. That is, the same movie or other content item that is recorded on disc 12 is recorded on disc 22. A person who appeared as an actor in the movie can use media player-based master device 20, and a fan of the actor or movie can use media player 12. The actor and fans can further participate in a teleconference or videoconference in which, for example, the fans can hear the actor's voice and see the actor's face, as described herein with regard to FIG. 3. In this manner, the actor can control the playback of disc 22 at a central location, and the playback of corresponding disc 10 and others at the fans' locations follows in synchronism with the playback of disc 22. For example, the actor can pause playback (e.g., by pressing a Pause button) at a certain scene in which the actor appears and discuss (via the teleconference or videoconference) the scene with the fans. In response, playback is paused on each of the fans' media players. When the actor is finished discussing the scene, the actor can continue playback (e.g., by pressing a Play button). In response, playback resumes on each of the fans' media players.

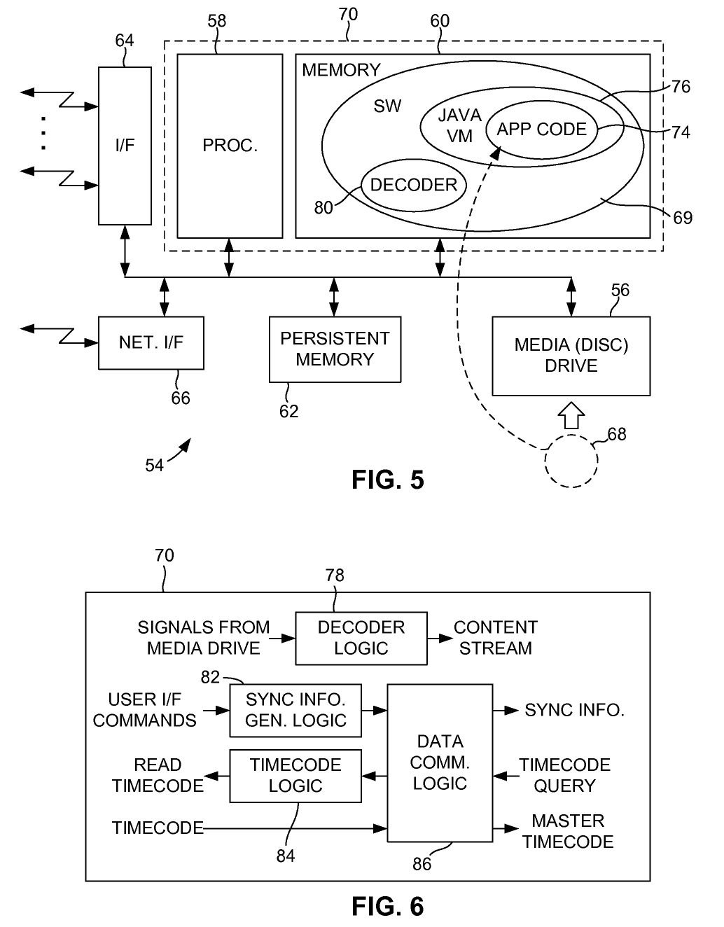

As illustrated in FIG. 5, a master device structure 54, which can represent the operational structure of master device 52, media player-based master device 20, computer-based master device 32, etc., includes a media drive 56 and other elements that allow it to function as described above. As master device structure 54 represents the structure of a computer-based media player, a smart media player, or the like, it characteristically includes at least the following computer-like elements that are interconnected via one or more data buses or other suitable means, as shown in FIG. 5: one or more processors 58, main or working memory 60, read-only or other persistent memory 62, interfaces 64 for connecting a television or other display (not shown in FIG. 5) and other input and output devices, and a network interface 66 for connecting to internet 30 (FIGS. 1-4) or other network.

In the exemplary embodiment, media drive 56 is a disc drive that can read a Blu-ray-compatible optical disc 68 that a user inserts into it. However, in other embodiments it can be any type of device that can receive and read any suitable type of packaged media, such as those described herein.

In operation, code or other software 69 is loaded into working memory 60 under control of processor 58 so that processor 58 can operate upon such code or other software 69 in a programmed manner. Accordingly, as programmed with the software elements described herein or other suitable software elements, the combination of processor 58 and working memory 60 (or other element or elements in which software elements are stored or reside) and any related elements defines a programmed processor system 70. Although not shown for purposes of clarity, programmed processor system 70 can include any other suitable hardware or software elements of the types commonly included in processor-based systems. Also, it should be noted that the combination of software elements and the medium on which they are stored or in which they reside (e.g., working memory 60 or persistent memory 62, disc 68, etc.) defines what can be referred to in the patent lexicon as a “computer program product” or, in combination with content, a “packaged media product.”

Although in the exemplary embodiment shown in FIG. 5, a unitary programmed processor system 70 is shown for purposes of clarity, other embodiments can include more than one such processor system. For example, in embodiments in which the master device comprises a combination of a computer and a media player, the computer and media player may each include its own processor system and related elements. In such an embodiment, the media player may receive and play the packaged media product, while the computer performs control functions, such as those relating to the synchronization feature of the present invention. In such an embodiment, while the media player portion of the master device may receive and play a packaged media product, the computer portion of the master device may separately receive and read a computer program product that comprises, for example, a disc on which program code is recorded. For purposes of clarity, however, in the exemplary embodiment the master device structure 54 is shown as having only a single processor system 70 that can control both the playback of disc 68 or other packaged medium as well as other functions, such as those relating to the synchronization feature of the present invention.

As indicated in broken line in FIG. 5 and described in further detail herein, when a user loads disc 68 into media drive 56, software elements that are stored on disc 68, such as portions of application code 74, are loaded into working memory 60. In the exemplary embodiment, application code 74 is in the Java language, and thus can be executed by a Java Virtual Machine (Java VM) 76, which is another software element. The manner in which a Java VM can execute Java code in a processor-based system is well understood in the art and therefore not described herein in further detail. Although in the exemplary embodiment the language of application code 74 is Java, it should be understood that in other embodiments application code 56 can be provided in any other suitable language or format and executed or otherwise acted upon in any other suitable manner. Also, although application code 74 is shown in this exemplary embodiment for purposes of clarity as being executable by Java VM 76, in other embodiments some or all application code can be executed separately from Java VM 76, such as directly by processor 58 or by processor 58 operating under a software system other than a Java VM.

Furthermore, although for purposes of illustration a software element, such as application code 74, may be shown and described herein as though it were a unitary element, persons skilled in the art recognize that such a software element can comprise any suitable number of portions or sub-elements, such as modules, code segments, objects, libraries, tables, instructions, etc., and that software elements may be loaded into working memory 60 in such portions on an as-needed basis, in accordance with conventional computing principles. It should also be noted that some or all of the above-described software elements, or additional software elements, can be loaded into working memory 60 from a source other than disc 68, such as persistent memory 62, a remote source (via network interface 66), or another disc drive (not shown) or similar storage device. Furthermore, although the exemplary embodiment includes persistent memory 62 and working memory 60, other embodiments can include any other memory types and arrangements.

As illustrated in FIG. 6, the operation of processor 58 upon software elements (e.g., application code 74, decoder 80, etc.) gives rise to dynamic logic structures in processor system 70. It should be noted that although in the exemplary embodiment this logic represents interconnections or other integrated structures in processor system 70 that are formed in accordance with software, in other embodiments such logic can equivalently represent discrete logic gates, memory elements and hard-wired or similarly pre-defined or static interconnections among such discrete elements. In the exemplary embodiment, this master device logic includes decoder logic 78, which receives signals that media drive 56 reads from disc 68 and, in response, produces the content stream representing the playing content item. Decoder logic 78 can include not only the core logic that performs specific decoding algorithms (e.g., MPEG) but also associated logic that enables decoder logic 78 to perform all processing necessary to produce a content stream usable by a television or other display. Although in the exemplary embodiment decoder logic 78 arises from operation of processor 58 upon a corresponding software decoder 80 (FIG. 5), in other embodiments such decoder logic can be embodied in any other suitable device or devices, such as a decoder chip. In still other embodiments, logic embodied in a processor system in combination with logic embodied in such other devices (e.g., a chip) can perform this decoding function. In the illustrated embodiment, the master device logic further includes synchronization information generator logic 82, timecode logic 84, and data communication logic 86, which operate as described in further detail herein.

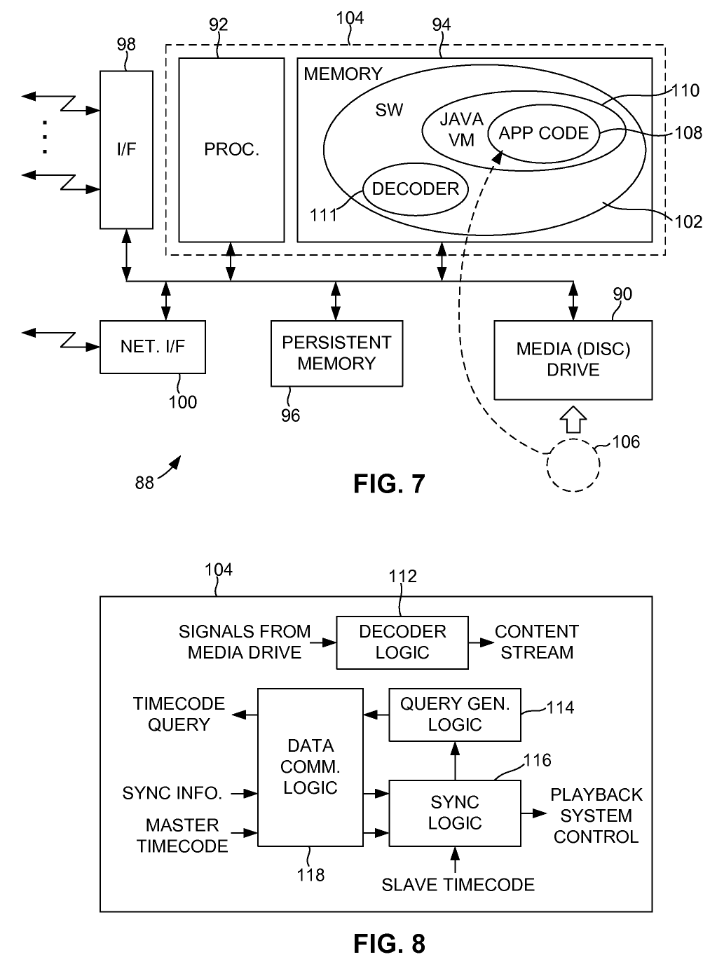

As illustrated in FIG. 7, a slave device structure 88, which can represent the operational structure of media player 12 (FIGS. 1-3) or other such slave devices 46, 48, 50, etc. (FIG. 4), is similar to master device structure 54 as described with regard to FIG. 6). Accordingly, slave device structure 88 includes a media drive 90 and other elements that allow it to function as described above. As slave device structure 88 represents the structure of standalone smart media player, it characteristically includes at least the following computer-like elements that are interconnected via one or more data buses or other suitable means, as shown in FIG. 7: one or more processors 92, main or working memory 94, read-only or other persistent memory 96, interfaces 98 for connecting a television or other display (not shown in FIG. 7) and other input and output devices, and a network interface 100 for connecting to internet 30 (FIGS. 1-4) or other network.

In operation, portions of software 102 are loaded into memory 94 and operated upon by processor 92 in a manner similar to that described above with regard to master device structure 54. As programmed with the software elements described herein or other suitable software elements, the combination of processor 92 and working memory 94 (or other element or elements in which software elements are stored or reside) and any related elements defines a programmed processor system 104. As indicated in broken line in FIG. 7 and described in further detail herein, when a user loads a disc 106 into media drive 90, software elements that are stored on disc 106, such as portions of application code 108, are loaded into working memory 94. In the exemplary embodiment, application code 108 can be executed by a Java VM 110. In the exemplary embodiment, application code 108 is not identical to application code 74 (FIG. 5), reflecting differences in operation between a slave device and a master device, as described in further detail herein. In other embodiments, however, such differences could be reflected in portions of the master and slave devices other than application code. In still other embodiments, such application code loaded into the master and slave devices could be identical, enabling each device to function as both a master and a slave. Also, in the exemplary embodiment the same content item, such as a movie, that is recorded on disc 106 is also recorded on disc 68.

As illustrated in FIG. 8, the operation of processor 92 upon software elements (e.g., application code 108, decoder software 111, etc.) gives rise to dynamic logic structures in processor system 104, in the same manner described herein with regard to processor system 70. Although in the exemplary embodiment this logic represents interconnections or other integrated structures in processor system 104 that are formed in accordance with software, in other embodiments such logic can equivalently represent discrete logic gates, memory elements and hard-wired or similarly pre-defined or static interconnections among such discrete elements. In the exemplary embodiment, this slave device logic includes decoder logic 112, query generator logic 114, synchronization logic 116, and data communication logic 118, which operate as described in further detail herein.

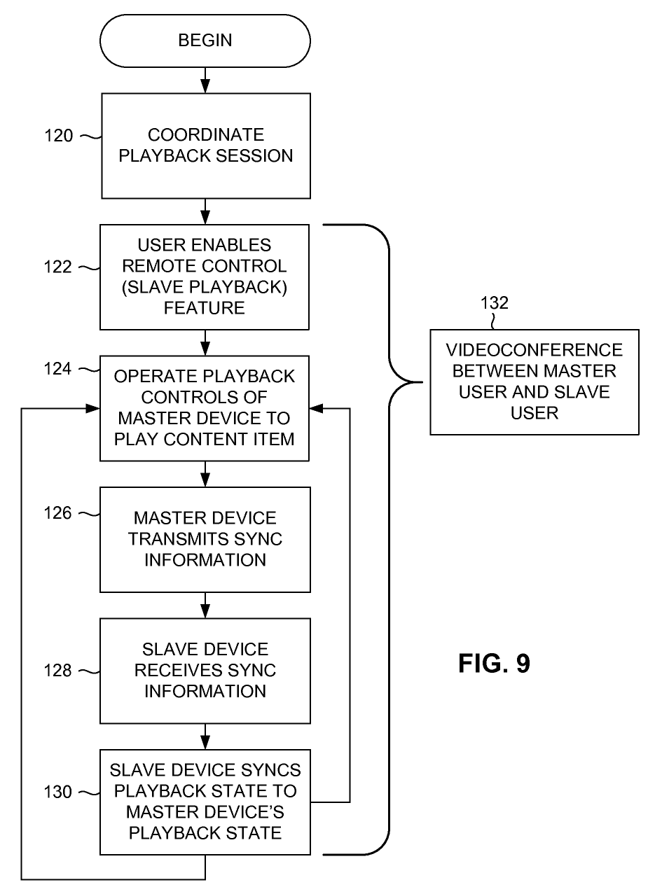

An exemplary method of operation is illustrated by the flow diagram of FIG. 9. Unless specifically stated otherwise herein, steps or acts described with respect to FIG. 9 can occur in any order. The exemplary method involves a master device, such as master device 52, media player-based master device 20, or computer-based master device 32, and a slave device, such as standalone media player 12, each operating primarily under the control of its respective application code. In view of the descriptions herein, persons skilled in the art will readily be capable of providing suitable application code and otherwise programming or configuring the master and slave devices to effect the exemplary method.

Although the remote control or master-slave playback feature described herein can be used for any purpose, in the exemplary embodiment it is used in combination with an audio or video conference between a user of a master device and one or more users of slave devices. As indicated by block 120 in FIG. 9, a playback session can be scheduled or otherwise coordinated between a master device (e.g., master device 52 in FIG. 4) and one or more users of slave devices (e.g., slave devices 46, 48, 50, etc., in FIG. 4). A playback session can be coordinated by, for example, publishing an announcement of a scheduled time for the playback session. In an embodiment in which the recorded content item is, for example, a movie, the master device user can be, for example, a person associated with the production of the movie, such as an actor, and a slave device user can be, for example, a fan of the actor. For example, a company that produced the movie or that produced or distributes the disc on which the content item is recorded can announce (e.g., via a web site relating to the company, the movie, the actor, etc.) that the actor will be conducting an event that includes a videoconference discussion of the actor's role in the movie in combination with a remotely controlled playback session. The announcement can explain that a fan who participates in the remotely controlled playback session will allow the actor to remotely control the fan's media player.

As indicated by block 122, and with further regard to FIGS. 7-8, a fan or other user can enable his media player (slave device) to be remotely controlled, by inputting a corresponding command to the media player. The slave device user can also load disc 106 on which the movie is recorded into media drive 90 of the slave device. The slave device user can perform these steps at any suitable time, such as just before a scheduled remotely controlled playback session is to begin. Although not shown in FIG. 7, the slave device can transmit an indication to the master device (e.g., via internet 30) that the slave device user has enabled the remote control or master-slave feature and is ready to participate in the playback session.

As indicated by block 124, and with further regard to FIGS. 5-6, the actor or other master device user can similarly load disc 68 into media device 56 and otherwise proceed to operate the master device. In operating the master device, the master device user can input commands relating to playback. For example, the master device can display a main menu (not shown), from which the user can select playback commands, such as Play, Pause, Stop, Forward and Reverse.

In response to the master device user selecting the Play command, decoder logic 78 and associated elements operate to read the movie or other content item from disc 68 and produce the displayable content stream. The master device user can view the movie on a television, computer screen, or other display that is connected to or part of the master device. Also in response to the master device user selecting the Play command, synchronization information generator logic 82 produces synchronization information, as indicated by block 126 in FIG. 9. For example, synchronization information generator logic 82 can produce an indication that the Play command has been selected. Alternatively, or in addition, synchronization information generator logic 82 can produce timecode information that indicates the then-current playback point in the content item. Data communication logic 86 causes the synchronization information to be transmitted to one or more slave devices via internet 30. Synchronization information can be transmitted at any suitable time, such as immediately in response to a Play command, at predetermined time intervals, or in an essentially continuous stream.

Similarly, in response to the master device user selecting other commands, such as Stop, Pause, Forward or Reverse, synchronization information generator logic 82 produces corresponding synchronization information. The synchronization information can similarly include an indication of the command that has been selected or, alternatively or in addition, the relevant timecode information.

As indicated by block 128 in FIG. 9, the slave device receives the synchronization information via internet 30. As indicated by block 130, and referring again to FIGS. 7-8, synchronization logic 116 receives the synchronization information from data communication logic 118 and generates commands or signals that control playback of disc 106. For example, synchronization logic 116 can generate commands that emulate the Play, Pause, Stop, Forward and Reverse that the slave device would normally, i.e., in the absence of the remote control feature being enabled, receive as user input from the slave device user. Thus, the playback state of the slave device is adjusted to match the playback state of the master device. Alternatively, or in addition, synchronization logic 116 can generate signals that incrementally adjust the playback point by, for example, controlling decoder logic 112 or related elements. For example, synchronization logic 116 can cause decoder logic 112 or related elements to advance or delay the outputted content stream so that the playback point or other playback state in the slave device more closely matches the playback point or other playback state in the master device.

As indicated by block 132, in accordance with another feature, the master device user and slave device user can participate in a videoconference during the time that the remote control feature is enabled on the slave device or otherwise in conjunction with the playback session initiated by the master device user. In an embodiment in which the master device user is an actor, and the slave device user is a fan, the actor can, for example, use the Forward command to locate a scene in the movie in which the actor appears, and then speak to the fan via the videoconference link, and the fan listen to the actor and see the actor's face, as in a conventional videoconference. The videoconference link can be between computers or other devices at the actor's and fan's locations. In some embodiments the conference can be a one-way videoconference in which the fan can see and hear the actor but the actor cannot see or hear the fan, but in other embodiments the conference can be a two-way videoconference in which both participants can see and hear each other. In some embodiments, the videoconferencing or audio conferencing system can be included in, i.e., integrated with, the master and slave devices by means of appropriate hardware (e.g., camera, microphone, etc.) and application software. For example, if a videoconferencing system is included in the slave device, a video image of the actor's face could appear on the television or other display in a box superimposed over the movie.

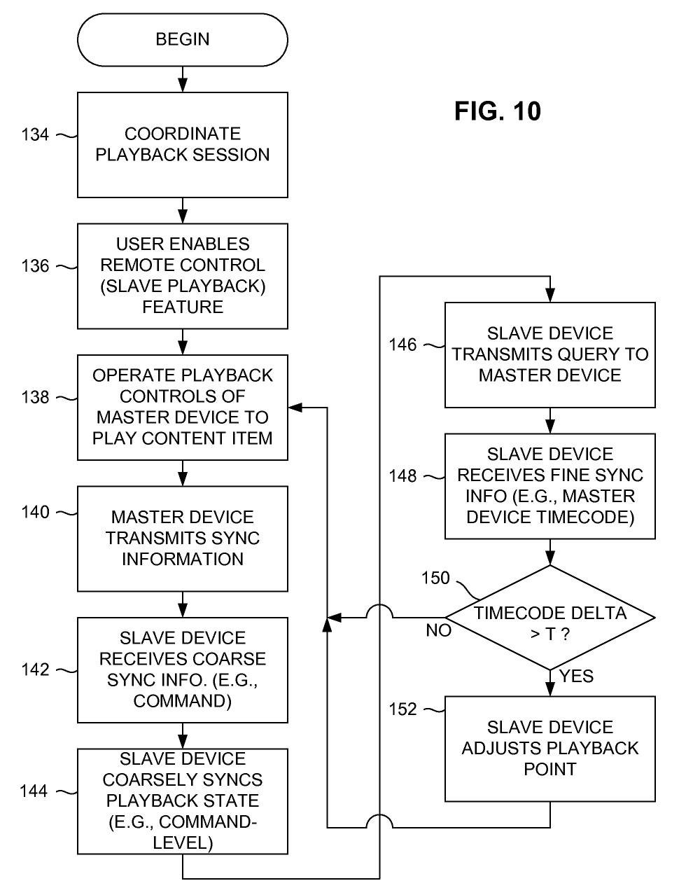

A method similar to that described herein with regard to FIG. 9 is illustrated by the flow diagram of FIG. 10. As blocks 134, 136, 138, 140, 142 and 144 are the same as blocks 120, 122, 124, 126, 128 and 130, they are not described again. Block 146 indicates that the slave device can not only receive synchronization information from the master device at the initiation of the master device, but in some embodiments can, alternatively or additionally, request synchronization information from the master device by transmitting a query. With further reference to FIGS. 7-8, query generator logic 114 can generate such a query. For example, query generator logic 114 can generate a query at predetermined time intervals or, alternatively or in addition, in response to an indication from synchronization logic 116 that the slave device playback is not sufficiently synchronized with the master device playback. Synchronization logic 116 can determine that the slave device is “out of sync” with the master device by, for example, comparing a timecode received from the master device with a timecode indicating the playback point in the slave device. Data communication logic 118 transmits the query.

The slave device can receive the query via internet 30. Referring again to FIGS. 5-6, in response to receiving the query (via data communication logic 86), timecode logic 84 can read the timecode representing the playback point in the master device. Data communication logic 86 can then transmit the timecode. The slave device can receive the timecode via internet 30.

As indicated by step 150, the slave device can determine whether the difference (or delta) between the received master device timecode and the timecode representing the slave device playback point exceeds some predetermined amount, indicating insufficient synchronization. If the delta exceeds this amount, the slave device can use the delta to adjust its playback state to more closely match, i.e., synchronize to, the playback state of the master device, as indicated by step 152.

A slave device can use synchronization information that indicates a playback command to make a coarse adjustment to its playback state. A slave device can use synchronization information that indicates a timecode to make a fine adjustment to its playback state. In FIG. 10, the adjustment indicated by block 144 represents such a coarse adjustment, while the adjustment indicated by block 148 represents such a fine adjustment. Although in the embodiment illustrated by the flow diagram of FIG. 10 there are only two gradations or levels of synchronization adjustment, i.e., coarse and fine, in other embodiments there can be more or fewer levels. Also, in embodiments similar to that described herein with regard to FIG. 10, the master device user and slave device user can participate in a videoconference during the time that the remote control feature is enabled on the slave device, as in the embodiment described herein with regard to FIG. 9. Conversely, in other embodiments similar to that described with regard to FIG. 9, the master device user and slave device user need not participate in a videoconference.

While one or more embodiments of the invention have been described as illustrative of or examples of the invention, it will be apparent to those of ordinary skill in the art that other embodiments and implementations are possible that are within the scope of the invention. Accordingly, the scope of the invention is not to be limited by such embodiments but rather is determined by the appended claims.

What is claimed is:

1. A method for remotely controlling a standalone media player via a data network, comprising:
using a master device to play back a packaged medium on which a content item is recorded, the master device having a media player user interface to respond to playback commands received from a user; and
transmitting synchronization information via the data network from the master device, the synchronization information configured to cause a remote standalone media player receiving the synchronization information via the data network to synchronize a playback state of the remote standalone media player to a playback state of the master device.

2. The method claimed in claim 1, wherein the data network includes a portion of the internet.

3. The method claimed in claim 1, wherein using a master device comprises using a master standalone media player.

4. The method claimed in claim 1, wherein using a master device comprises using a computer.

5. The method claimed in claim 1, wherein transmitting synchronization information comprises transmitting indications of playback commands.

6. The method claimed in claim 1, wherein transmitting synchronization information comprises transmitting timecode indications.

7. The method claimed in claim 1, further comprising receiving a query via the data network from the remote standalone media player, wherein transmitting synchronization information is performed in response to the query.

8. The method claimed in claim 1, further comprising, simultaneously with using the master device, communicating audio information representing a voice of a person who is using the master device.

9. The method claimed in claim 1, further comprising, simultaneously with using the master device, communicating video information representing an image of a person who is using the master device.

10. The method claimed in claim 1, wherein using a master device comprises a person associated with production of the content item using the master device.

11. A standalone media player operable to play a packaged medium on which is recorded in machine-readable form a content item, the media player comprising:
a playback subsystem comprising a media drive for reading the content item recorded on the packaged medium and decoder logic for producing signals representing a content stream;
data communication logic, the data communication logic causing the standalone media player to receive synchronization information via a data network from a master device; and
synchronization logic, the synchronization logic causing the playback system to synchronize a playback state of the playback system to a playback state of the master device in response to received synchronization information.

12. The standalone media player claimed in claim 11, wherein the data network includes a portion of the internet.

13. The standalone media player claimed in claim 11, wherein the synchronization information comprises playback commands.

14. The standalone media player claimed in claim 11, wherein the synchronization information comprises timecode data.

15. The standalone media player claimed in claim 11, further comprising query logic, the query logic causing the standalone media player to transmit a query via the data network to the master device, wherein the synchronization information is responsive to the query.

16. A packaged media product for playback on a standalone media player, the packaged media product comprising a player-readable medium on which is recorded in machine-readable form a content item and code for instructing the standalone media player to:
receive synchronization information via a data network from a master device; and
synchronize a playback state of the playback system to a playback state of the master device in response to received synchronization information.

17. The packaged media product claimed in claim 16, wherein the data network includes a portion of the internet.

18. The packaged media product claimed in claim 16, wherein the synchronization information comprises playback commands.

19. The packaged media product claimed in claim 16, wherein the synchronization information comprises timecode data.

20. The packaged media product claimed in claim 16, wherein the code is further for instructing the standalone media player to transmit a query via the data network to the master device, wherein the synchronization information is responsive to the query.
